(19) United States
(12) Patent Application Publication
(10) Pub. No.: US 2010/0010978 A1
(43) Pub. Date: Jan. 14, 2010

(54) METHOD AND SYSTEM TO SEARCH FOR TRAVEL PRODUCTS

(75) Inventors: Sean Peter Carapella, Somerville, MA (US); James Edwards Hetzel, Oxford, MI (US); Mary G. Keagul, Lexington, MA (US); Michelle Marguerite Mott, Rockland, MA (US); Mahenthiran Venugopal, Waltham, MA (US)

Correspondence Address: YOUNG & THOMPSON, 209 Madison Street, Suite 500, Alexandria, VA, 22314, US

(73) Assignee: AMADEUS S.A.S., Biot (FR)

(21) Appl. No.: 12/171,527

(22) Filed: Jul. 11, 2008

(51) Int. Cl. G06F 7/06; G06F 17/30

(52) U.S. Cl. 707/4; 707/E17.014

(57) ABSTRACT

Method of searching for travel products related to trip components of a trip includes building a search request by inputting search criteria for a plurality of trip components in a single search window of a user interface of a user device; sending the search request to an application server for initiating a search process; wherein the search process includes, at the application server, splitting the search request to build sub-requests each related to one single trip component of the trip and sending in parallel each of the sub-requests to at least one provider of travel products related to the trip component of the sub-request.

### FIELD OF THE INVENTION

The present invention relates to a system and method of searching for travel products. It particularly enables clients to search and review travel options in the perspective of making bookings in relation with different transportation means and services such as, but not limited to, air, rail, car, and/or hotel in relation with other aspects of a trip such as, but not limited to, managed travel, vendor discounts, and/or travel planning tools.

### BACKGROUND OF THE INVENTION

Travel planning and reservation systems have long been in use. First, essentially by agents of traditional travel agencies generally affiliated with a global distribution system (GDS) that remotely provides them with all the necessary support from its large networking, storing and computing resources. Existing reservation systems let a traveler or any other user select the days that they wish to travel and their origin and destination. Based on these selections, the system tells the user both the fares and rates available and the companies offering these fares and rates.

These existing systems require the user to sequentially search for their desired travel components such as air, car and hotel. Additionally, the user (often the traveler or a travel arranger) must then search through the results displayed to find the itinerary that best matches the trip requirements and defined travel policy. This process can be cumbersome as the user may not be fully aware of all applicable travel policy criteria.

A partial solution to this problem has been proposed in the published International patent application WO02/08960. This document discloses a graphical user interface where display areas are respectively dedicated to air, car and hotel information. It however suffers important limitations. First, it focuses on data gathered from one or more specific databases and provides a display that only review the static data collected. The system of WO02/08960 is also very generic and is obviously not adapted for efficiently displaying in the same page information related to various trip components.

There is a need for a system and method improving the search of travel products and the display of the results each time a plurality of trip components is involved by the travel.

It is an object of the invention permit that all itinerary search criteria be entered, for all components (e.g. air, car hotel) in one “form” at the beginning of the search process.

Alternative or cumulative objects of the invention are given hereafter:
Allow for simultaneous and parallel searching of multiple types of trip components (e.g. air, car and hotel);
Allow the user to select desired options for all components from the single integrated display;
Display optimal itinerary based on policy and scoring that provides optimal value and/or convenience to the end-user;
Minimize clicks and time involved in the searching and more generally in the booking process;
Communicate travel policy and encourage the booking of compliant travel;

Further objects, features and advantages of the invention will become apparent to the ones skilled in the art upon examination of the following description in reference to the accompanying drawings.

### SUMMARY OF THE INVENTION

The invention is a system and method of searching for travel products in view of making travel reservations. It enables the user—who can be a traveler or another person such as an arranger—to input the search criteria of a complex trip request within a single search window. The complex trip request corresponds to a trip made of a plurality of components such as air, car or hotel. The invention processes the search according to the input criteria in such a way that queries (or sub-requests) are created and sent in parallel to travel providers. This ensures a dynamic handling of the request with a reduced response time. The number and the type of travel providers that can be impacted by the search are not limited.

In one particular aspect of the invention, the search results are provided to the user in the form of a single display integrating travel options for all of the trip components.

In another aspect of the invention, travel policy rules are applied to filter the replies obtained from the travel providers and the system only returns to the user a selection of travel products that best match his/her wishes or his/her travel constraints. Travel constraints can be, but are not limited to, a corporate policy that determines the traveling conditions of their employees. Policy may be determined by any entity interested in managing travel spend (e.g., travel agencies, loyalty redemption providers, cruise lines, leisure groups, airlines, etc). . . . The filtering also ensures that a reduced but efficient set of travel options are proposed to the user. This is important in the perspective of providing an all-encompassing but readable display of the results.

Another advantage of the invention is that it can be implemented with an application server located between the user and the travel providers. This does not imply any strong modifications to the architecture of the current network-based computer reservation systems. The application server also acts as an intermediate means and can communicate with various types of travel providers such as GDS's, airline or other direct content systems, third party websites. . . .

More precisely, the invention relates to a method of searching for travel products related to trip components of a trip, comprising: Building a search request by inputting search criteria for a plurality of trip components in a single search window of a user interface of a user device; Sending said search request to an application server for initiating a search process; Wherein the search process comprises, at the application server, splitting the search request to build sub-requests each related to one single trip component of the trip and sending in parallel each of said sub-requests to at least one provider of travel products related to the trip component of the sub-request.

Optionally the method may also include any of the steps indicated below:
at the application server, receiving replies from the providers of travel products, said replies including description data about travel products matching the sub-requests and forwarding at least a portion of said description data to the user device.
in a single result window of the user interface of the user device, displaying a description about a set of travel products included in said description data for each trip component.
at the level of the user device, sending a single search request for a plurality of trip components on the basis of the single search window, selecting travel products displayed on the single result window and submitting the selection to the application server, receiving and displaying a single final window comprising confirmation data about the selected travel products and submitting a single confirmation message to the application server.
the trip components may include, but are not limited to: car rental, flight and hotel accommodation.
filtering the replies to restrict the number of travel products for each trip component to be displayed on the user device.
the number of travel products for each trip component to be displayed at the user interface of the user device is restricted by assigning to each trip component a maximum number of travel products to be displayed.
the data related to travel products that failed to pass the filtering of the replies are stored at the level of the user device.
the search process comprises the step of applying travel policy rules to enrich the search criteria of the search request when building the sub-requests.
in a single result window of the user interface of the user device, displaying a description about a set of travel products included in said description data for each trip component and returning information data about the applied travel policy rules to the user device and displaying the information data in the single result window.
the travel policy rules are stored in a repository at the application server.
accessing the repository from an administrator device to manage the travel policy rules.
the maximum number of travel products to be displayed for each trip component is stored in a repository at the level of the application server.

The invention also relates to a system to search for travel products related to trip components of a trip, comprising an application server having means adapted for:
building a single search window of input of search criteria for a plurality of trip components;
sending said single search window to a user device for display on the user interface of the client device;
receiving a search request from the user device, said search request comprising search criteria;
splitting the search request to build sub-requests each related to one single trip component of the journey;
sending in parallel each of said sub-requests to at least one provider of travel products related to the trip component of the sub-request.

According to optional aspects of this system, the application server further comprises:
means adapted for receiving replies from the providers of travel products, said replies including description data about travel products matching the sub-requests and for forwarding at least a portion of said description data to the user device.
means adapted for building a single result window to be sent to the user device for displaying a description about a set of travel products included in said single response for each trip component.
means adapted for filtering the replies to restrict the number of travel products for each trip component to be sent to the user device.
a repository of travel policy rules and means adapted for enriching the search criteria of the search request when building the sub-requests.

### BRIEF DESCRIPTION OF THE DRAWINGS

FIG. 1 depicts an overview of one embodiment of the invention;

FIG. 2 illustrates a window to be used for administration purposes;

FIG. 3 is a screenshot of a single search page;

FIG. 4 gives a partial view of a single result display showing air results;

FIG. 5 gives a partial view of a single result display showing car results;

FIG. 6 gives a partial view of a single result display showing hotel results;

FIG. 7 is a screenshot of a page useful in case of justification;

FIG. 8 gives a partial view of a page displayed to complete a booking;

FIG. 9 and FIG. 10 are two other partial views of the page of FIG. 8.

FIGS. 11 to 13 illustrate three windows that are successively displayed and which are sufficient to make reservations in a preferred embodiment of the invention.

### DETAILED DESCRIPTION

The following detailed description refers to the accompanying drawings. While the description includes exemplary embodiments, other embodiments are possible, and changes may be made to the embodiments described without departing from the spirit and scope of the invention.

The following terms are used throughout the following detailed description and are defined as follows:
A trip component is an item of a complex trip and corresponds to a type of travel services. This is not limited to but includes: air transportation (one or more flight legs), hotel accommodations, car rental services, railways, etc. . . .
A travel product refers to a commercial offer of service in connection with one trip component. In case of air transportation, the travel product is typically a flight or a combination of flights.
A user may be the traveler himself or an arranger such as a corporate travel arranger or a travel agent. While some examples below make reference to a corporate environment, the invention extends to any kind of managed travel. This includes, but is not limited to, loyalty redemption groups, travel agencies, leisure travel groups, cruise lines, consumer market, airlines and other vendors, etc. . . .
Search criteria correspond to the data entered by the user for defining the parameters of his trip. The criteria may vary to some extent depending on the case and normally comprises:
   For transportation trip components: an origin and a destination, dates or intervals of date.
   For hotels: arrival and departure dates, location or area of the hotel. . . .

Some search criteria can be common to the various trip components.
The user device is any kind of computer device integrating a graphical user interface and having connection means to a network which can be the internet using the World Wide Web application. A typical laptop or a notebook is convenient.
A travel provider is a company specialized in the distribution of travel products. Examples are GDS's, airlines and other direct content systems, third party websites. . . .
A travel policy refers to a set of rules assigned to a traveler or a group of travelers and defining some travel parameters which can be combined (or compared in case they are not consistent) with the search criteria. In some instances, the travel policy reflects the travel preferences of the traveler such as smoking/non smoking, room type. . . . In other cases the travel policy includes mandatory rules to observe such that “the traveler is not authorized to travel in first class” in a corporate travel context.
An administrator is a person in charge of setting and managing the present system. The administrator can be a travel manager of an organization or the web site administrator.

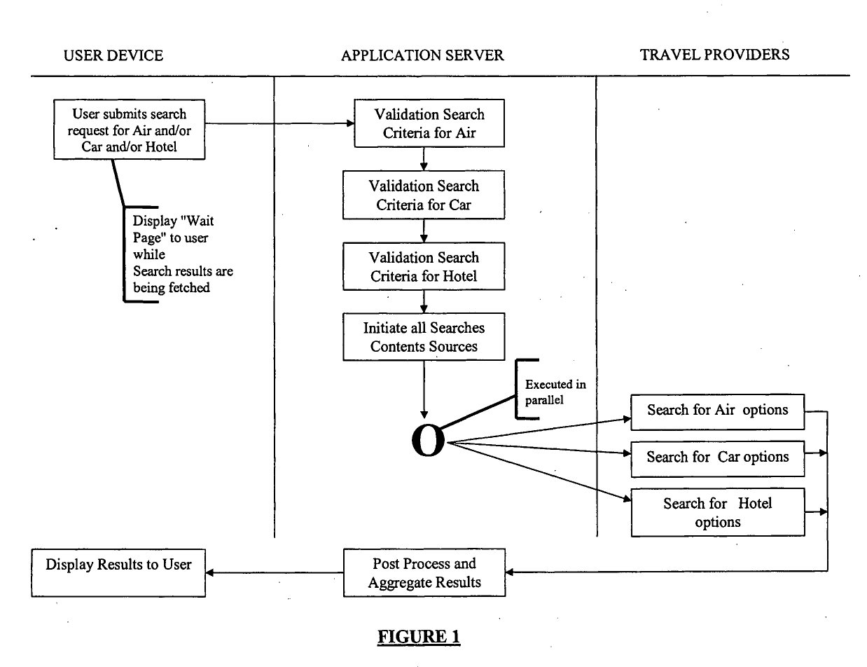

FIG. 1 gives a global illustration of the invention. A user device provides to the user an interface with the rest of the system. At a first stage of the search, the graphical user interface of the device display a search window. The display can occur via a standard browser program such as Internet Explorer®. The window integrates all the aspects of the trip and simultaneously presents search masks for a plurality of trip components. Only for illustration purpose, the trip components indicated in the figure are air, car and hotel. The user device is in communication with an application server which is typically a remote computer device acting as server. It is at an intermediate location between the user and travel providers. The application server comprises a processor and computer programs with instructions to perform actions specific to the invention as will be described later in more details. Communications means link the application servers to the travel provider computer systems. Again standard communication means can be implemented notably via internet. The travel provider systems are not described in detail in the present description but can be any existing systems used by airlines, vendors & suppliers, GDS's, etc. for processing travel searches.

In a preferred embodiment, an administrator device—typically a computer device—is connected to the rest of the system and authorizes an administrator to manage some aspects of the invention.

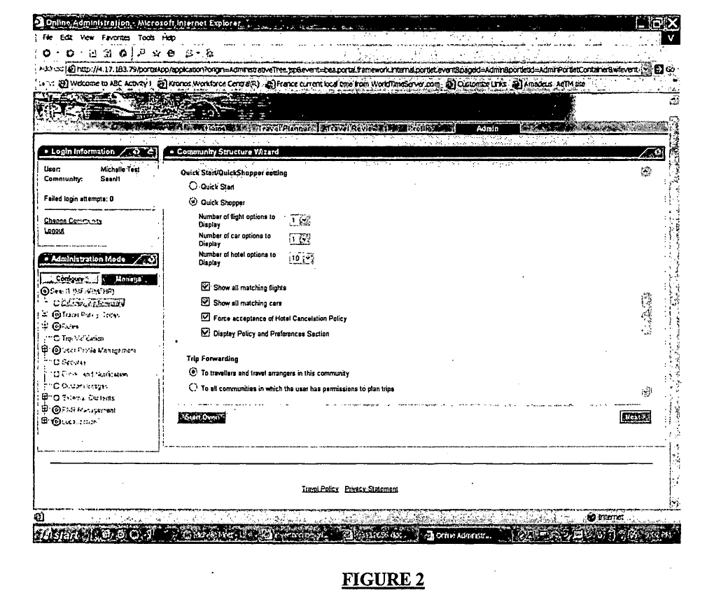

FIG. 2 illustrates the fact that the number of results returned (maximum number of travel products to be displayed for each trip component) is based on the rules set up by the administrator and the number of options set by the administrator. Some of the other settings that an administrator can choose to set include showing all flights and/or cars, to force a traveler to accept the cancellation policy of the hotel booked and whether the site administrator must display the policy and preferences section or not.

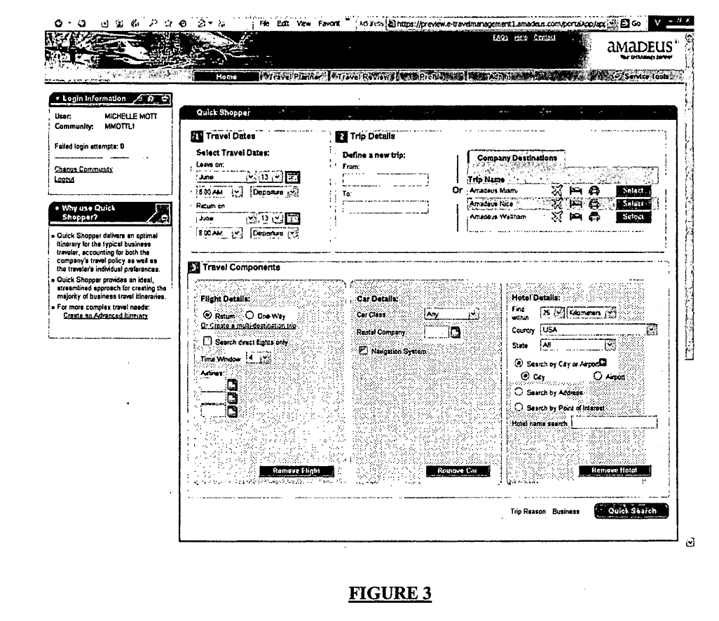

Turning now to FIG. 3, the user initiates the search by entering the search criteria once. The examples of search criteria mentioned in the description are not limiting and are only given for illustration purposes. The user enters the dates and times desired, he/she then enters either the city pair for the trip or he/she can select from a list of predefined destinations. When choosing from the predefined destinations the configured airports or cities for that destination will be used for the search. A different city or airport code can be used for each component without the user needing to do separate searches. For example, a company may have a location in Schaumburg, Ill. so they would want to set up a predefined destination that would have flights going to Chicago O'Hare airport, picking up a car at the same location but then staying at a hotel in Schaumburg. With this location set up the user would pick the one location from the list and the appropriate city codes would be sent in the search.

There are several other optional fields the user can elect to fill in to further refine the search:

Flight Details

For flights, either one way or round trip can be searched for. The traveler could elect to search for direct flights only or a mix of direct flights and connections, a time window can be set (this is the number of hours before and after the requested time to look for flights) and up to 3 airlines can be requested.

Car Details

The car search offers the ability to request a particular car class, a specific car vendor and to include a request for a navigation system in the rental car.

Hotel Details

The hotel search offers even more flexibility. A traveler can set the radius in which to search, the country and state where they are traveling to, the type of search they wish (options include at the airport or a city location, at or near a specific address or by a point of interest) and the ability to request a specific hotel by name.

Upon clicking <<search>>, the user sends a request incorporating the search criteria to the application server. The request is parsed and the different trip components are identified. Preferably, the traveler is also identified and his/her policy rules, if any, are retrieved from a repository. The search criteria of each trip component are validated as to their coherence and their consistency with the travel policy rules. If the validation step is successful, the application server builds queries to be sent to the travel providers. The queries are sub-requests based on the search criteria of the user's request but focusing only on the search criteria relevant for the trip component they are dedicated to. For example, a sub-request for a flight search to be sent to airlines will only specify criteria useful for such searches. The sub-requests can also include further search parameters particularly in application of the travel policy rules.

At this point the application is searching for flights, car and hotel in parallel as shown in FIG. 1. The complete search only takes the time needed to process the longest component. For example if the air takes 40 seconds to return, the car 10 and the hotel 50 the traveler has all of his/her options displayed in 50 seconds. The results of the sub-requests may be returned and displayed asynchronously in the single window (i.e. display results per component as they are returned so that in the example above the user would start to see car results within 10 seconds.) Alternatively, the results can be displayed synchronously in the single window (i.e. waiting to display all components after all results are returned).

The data about travel products embedded in the replies obtained from the travel providers are forwarded to the user device and accumulated at the browser level: the content of the replies is analyzed and forwarded to the user by constructing at least one response sent to the user device. A filtering can be made in view of the travel policy rules. The responses integrate the results for all the trip components.

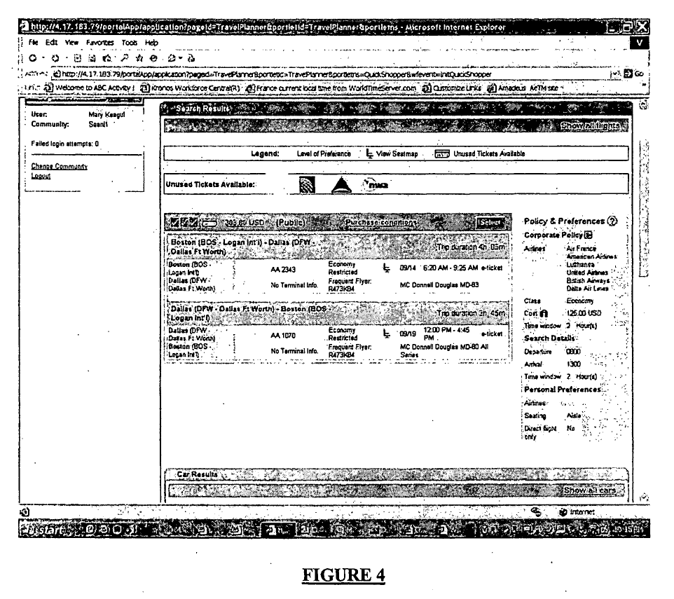

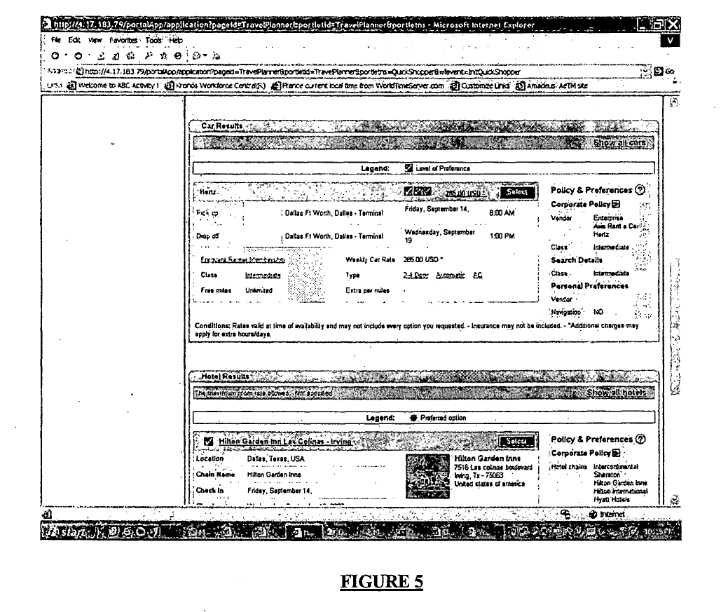

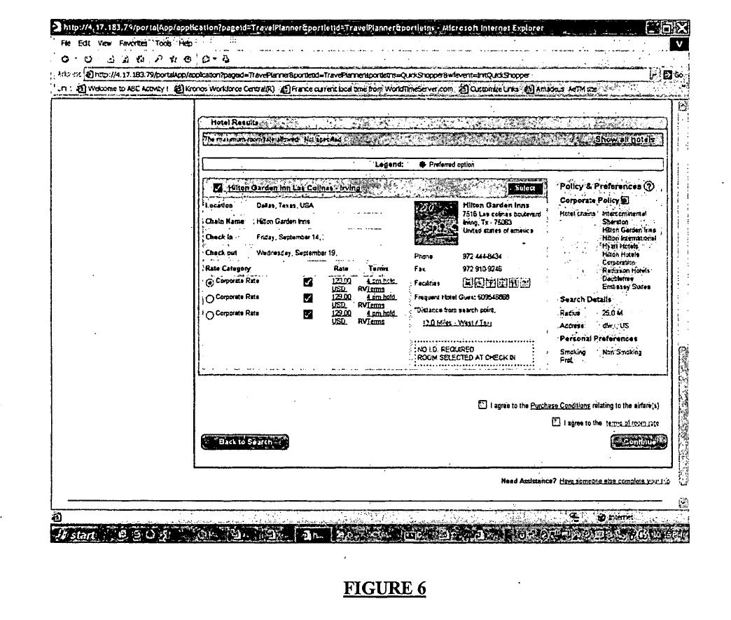

FIGS. 4, 5 and 6 illustrate an example of the single result window that is displayed to the user upon reception of the response. In this embodiment, the trip results are displayed along with a summary of the applied policy rules as shown in the areas entitled “policy and preferences” in FIGS. 4 to 6. Preferably the policy summary is split in various window areas placed in correspondence with each trip component. The user can then readily check the travel policy rules which have been applied for the given trip component.

Some further explanations as to the single result display are given hereafter:

The results for each trip component come back all on the same page without having to make any selections or go to another page to view the car or hotel. “Show all flights, car or hotel” can be clicked to see all of the options returned for these searches.

Policy and Preferences

The Policy and Preferences section provides information to the traveler on why the results displayed were returned. The details in each of the managed travel policy sections give information that is obtained from the rules configured by the administrator and are based on the managed travel policy. Preferred vendors, time window, cost grace amount, class of service and car class are some of the policy items displayed. The search details section is based on the information the traveler has provided when entering the search. Personal preferences of the travelers are shown such as aisle or window seats, or smoking vs. non-smoking hotel rooms. A link to the full travel policy is also included in this section for easy reference.

Flight Results

The flights returned are the top options based on configuration and managed travel policy. Using the invention in combination with a scoring feature will ensure the options returned to the traveler are the best options possible to meet the traveler and the travel manager's needs. The scoring feature allows an administrator to define points for certain criteria and rank the flight options accordingly. The flights with the 5 (this number is only an example) best scores would then be the options displayed to the traveler.

Any frequent flyer numbers already in the travelers profile are displayed on the appropriate flights. In the event a traveler has not added a frequent flyer number to his/her profile and wish to add it to the reservation a link displays allowing this number to be added to the current booking.

Car Results

The car options that are returned are up to the top 5 (this number is only an example) options based on configuration and managed travel policy. One of the biggest challenges of returning the options all on one page was what options would be returned when one or more locations have multiple airports and the search was done by a city name or city code. The flights returned and selected could be to and from any of the airports. Example: Chicago could return flights to/from O'Hare or Midway airports. The application allows the invention to search for all possible combinations of pick up and drop off points. Once the traveler selects his or her flight the options that match the arrival and departure airports are displayed. This is all done within the same page.

Frequent traveler numbers also display for the car options if a number is stored in the traveler profile; if no number is present a link is provided to add a frequent traveler number to the current booking.

Hotel Results

The hotel search may be accomplished via a two step process. The first step is to send one request to retrieve a list of available properties (a.k.a. Multi-Property Search). Step two is where bursting is introduced. Multiple new requests—one per property—are sent in parallel to retrieve hotel room & rate information (a.k.a. Parallel Single Property Searches).

Within the hotel results the traveler has access to the hotels terms and cancellation policy, details about the hotels amenities and facilities, the address, fax and phone number and pictures of the hotel if available. The room type with the rates are listed out and by selecting a room the traveler is shown the details for that room such as king or queen size bedding.

Frequent traveler numbers also display for the hotel options if a number is stored in the travelers profile. If no number is present a link will be provided to add a frequent traveler number to the current booking.

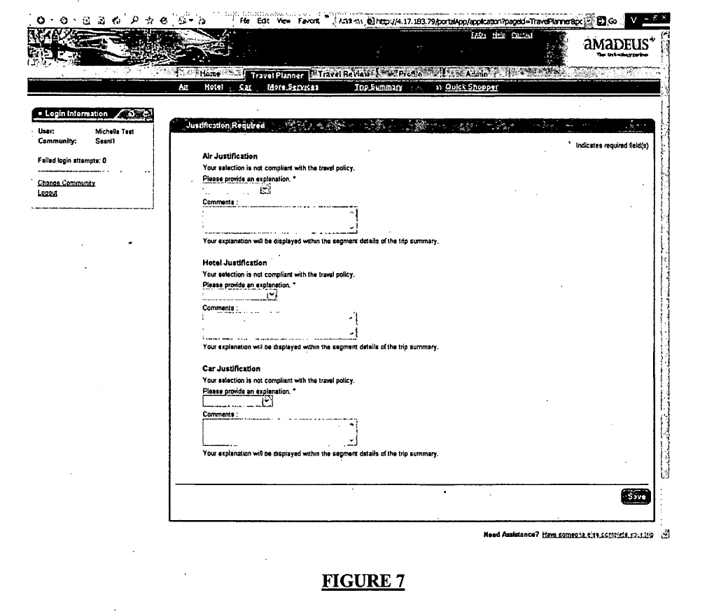

FIG. 7 shows another screenshot concerning justifications. This step is optional in the invention. Justification for each component is normally displayed after selecting each component and each is displayed on its own page. The display of the present invention has combined all justifications into one page. Upon selecting a flight, car and hotel and continuing if the traveler is out of policy on any or all of the components they are brought to a justification page where any of the required justification fields are displayed. The traveler enters each reason and continues to finalize the booking.

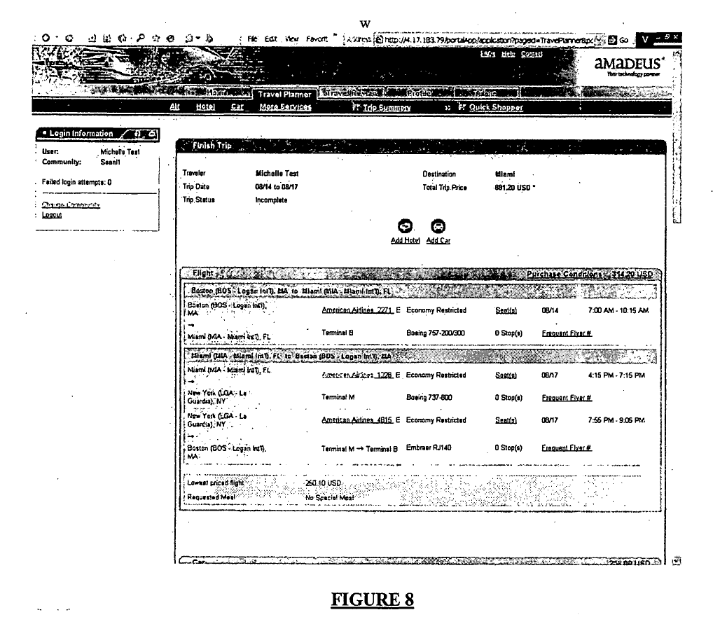

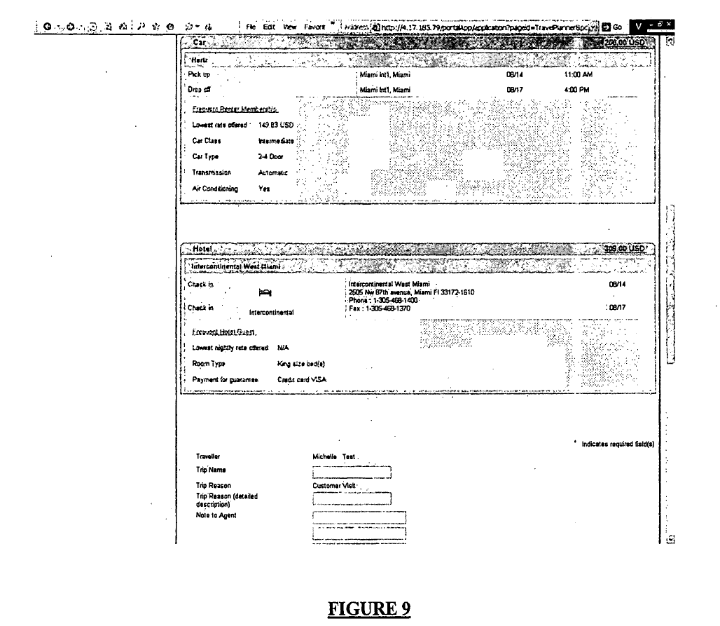

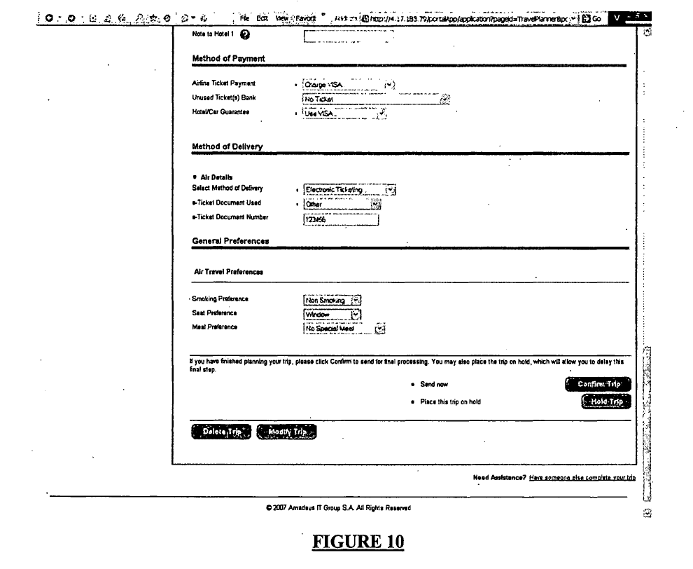

FIGS. 8, 9 and 10 illustrate what can be the last page to be reviewed by the user: Upon clicking continue from the search results page or save from the justification page the user is brought to the “finish trip” page. Here the itinerary is recapped and any fields required by the travel manager are displayed. Once the required data is entered the user can either confirm and send for ticketing or place on hold.

The invention is not limited to any number of travel components, requests and/or results. For example, components could be increased to also include rail, limo service, ferry service, cruise, etc. . . . Request and result sets could be as few as 1 and as many as necessary. These are completely configurable.

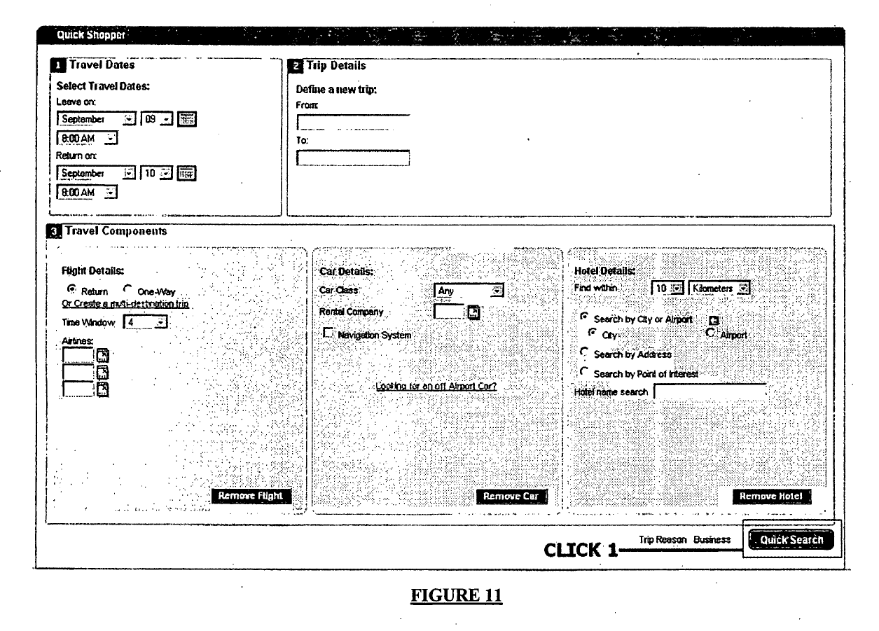

FIGS. 11 to 13 depict three windows that can successively be displayed at the user interface. These windows reflect the ability to search for an itinerary and book with just 3 clicks from the user.

FIG. 11 shows a single search window for entering all necessary search criteria for the trip (for all trip components). This has already been described in reference to FIG. 3. By activating the icon “Quick Search” (for example via a keyboard, a mouse or any other device) the request is sent to the application server. This corresponds to “Click 1” in FIG. 11.

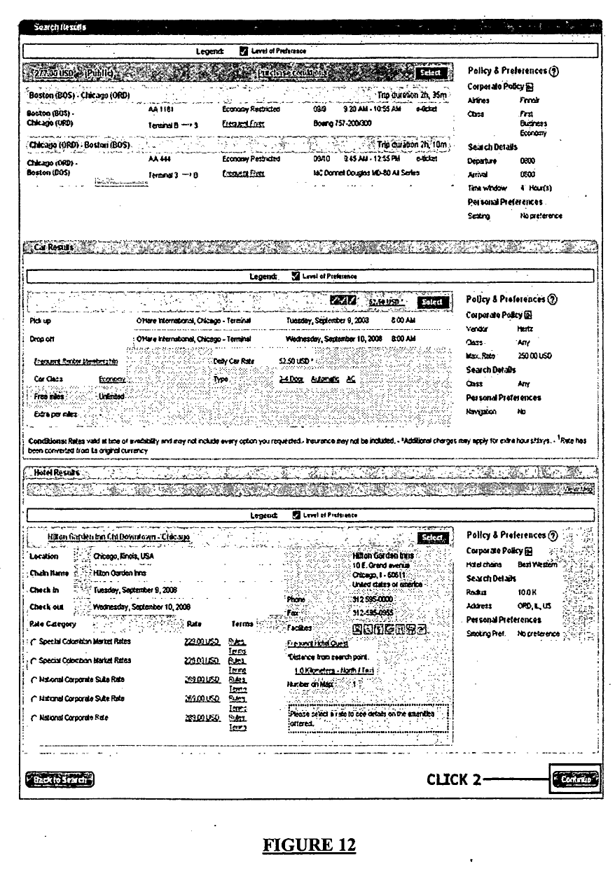

This window is followed by a single result window for which an example is given in FIG. 12. The results for all the trip components are displayed in this window. This was already explained in reference to FIGS. 4, 5, 6. The result window gives the user the ability to select the items (travel products) he wishes for the trip. He can then activate the icon “continue” corresponding to “Click 2” in FIG. 12.

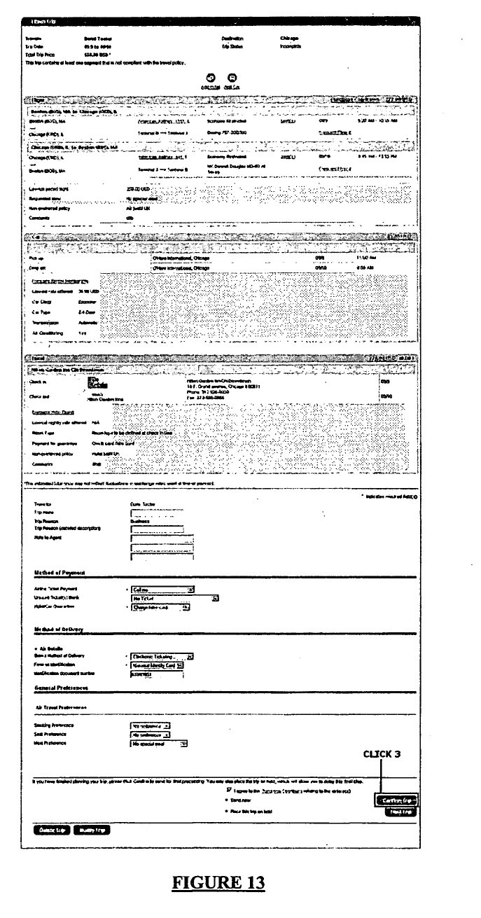

The selection is then transferred to the application server for preparing the final processing of the booking. A single final window is then transmitted and displayed at the user device, as shown in FIG. 13. A summary of the selected travel products is presented. In some cases, further information is requested and the user makes the appropriate inputs. He can then confirm the trip by activating the icon “confirm trip” which corresponds to the “Click 3”.

This series of three windows is sufficient for completing the whole search and booking process, even if the trip comprises a plurality of trip components.

An alternative embodiment of the invention may include the content and the functionality of the current three windows (search, result and final windows) in a single page.

The page can be updated at each stage of the search and booking process.

What is claimed is:

1. Method of searching for travel products related to trip components of a trip, comprising:
Building a search request by inputting search criteria for a plurality of trip components in a single search window of a user interface of a user device;
Sending said search request to an application server for initiating a search process;
wherein the search process comprises, at the application server, splitting the search request to build sub-requests each related to one single component of the trip and sending in parallel each of said sub-requests to at least one provider of travel products related to the trip component of the sub-request.

2. The method of claim 1 further comprising the step of, at the application server, receiving replies from the providers of travel products, said replies including description data about travel products matching the sub-requests and forwarding at least a portion of said description data to the user device.

3. The method of claim 2 further comprising, in a single result window of the user interface of the user device, displaying a description about a set of travel products included in said description data for each trip component.

4. The method of claim 3 comprising the steps, at the level of the user device, of:
i—sending a single search request for a plurality of trip components on the basis of the single search window;
ii—selecting travel products displayed on the single result window and submitting the selection to the application server;
iii—receiving and displaying a single final window comprising confirmation data about the selected travel products and submitting a single confirmation message to the application server;

5. The method of claim 4 wherein the content and functionality of said single search window, said single result window and said single final window are included in a single page.

6. The method of claim 2 comprising filtering the replies to restrict the number of travel products for each trip component to be sent to the user device.

7. The method of claim 6 in which the number of travel products for each trip component to be displayed at the user interface of the user device is restricted by assigning to each trip component a maximum number of travel products to be displayed.

8. The method of claim 6 wherein the data related to travel products that failed to pass the filtering of the replies are stored at the level of the user device.

9. The method of claim 2 wherein the search process comprises the step of applying travel policy rules to enrich the search criteria of the search request when building the sub-requests.

10. The method of claim 9 comprising, in a single result window of the user interface of the user device, displaying a description about a set of travel products included in said description data for each trip component and further comprising returning information data about the applied travel policy rules to the user device and displaying the information data in the single result window.

11. A system to search for travel products related to trip components of a trip, comprising an application server having means adapted for:
building a single search window of input of search criteria for a plurality of trip components;
sending said single search window to a user device for display on the user interface of the client device;
receiving a search request from the user device, said search request comprising search criteria;
splitting the search request to build sub-requests each related to one single trip component of the journey;
sending in parallel each of said sub-requests to at least one provider of travel products related to the trip component of the sub-request.

12. System according to claim 11 wherein the application server further comprises means adapted for receiving replies from the providers of travel products, said replies including description data about travel products matching the sub-requests and for forwarding at least a portion of said description data to the user device.

13. System according to claim 12 wherein the application server further comprises means adapted for building a single result window to be sent to the user device for displaying a description about a set of travel products included in said single response for each trip component.

14. System according to claim 12 wherein the application server further comprises means adapted for filtering the replies to restrict the number of travel products for each trip component to be sent to the user device.

15. System according to claim 12 wherein the application server further comprises a repository of travel policy rules and means adapted for enriching the search criteria of the search request when building the sub-requests.
